(19) United States
(12) Patent Application Publication
(10) Pub. No.: US 2014/0146017 A1
(43) Pub. Date: May 29, 2014

(54) OPTICALLY-SENSITIVE TOUCH DISPLAY

(71) Applicants: HONG FU JIN PRECISION INDUSTRY (ShenZhen) CO., LTD., (US); HON HAI PRECISION INDUSTRY CO., LTD., New Taipei (TW)

(72) Inventor: CHAO-JUN XIAO, Shenzhen (CN)

(73) Assignees: HON HAI PRECISION INDUSTRY CO., LTD., New Taipei (TW); HONG FU JIN PRECISION INDUSTRY (ShenZhen) CO.,LTD., Shenzhen (CN)

(21) Appl. No.: 13/873,255

(22) Filed: Apr. 30, 2013

(30) Foreign Application Priority Data
Nov. 27, 2012 (CN) 201210490650X

(51) Int. Cl. G06F 3/042

(52) U.S. Cl. CPC G06F 3/0421
USPC 345/175

(57) ABSTRACT

An optically-sensitive touch display includes a processor with n output ports and n input ports. A scanning circuit includes n column wires and n row wires, constituting a matrix including numerous intersection points. Each intersection point contains a light emitter and a light receiver, and in a scanning period, the processor receives a signal as to a change in resistance at a particular intersection, enabling the processor to determine that a touch ahs been applied to a particular intersection point.

### BACKGROUND

1. Technical Field

The present disclosure relates to touch displays, and particularly to a touch display sensitive to light.

2. Description of Related Art

Although conventional touch displays can satisfy basic requirement, a new type of touch display sensitive to light is still needed.

### BRIEF DESCRIPTION OF THE DRAWINGS

Many aspects of the present disclosure are better understood with reference to the following drawings. The units in the drawings are not necessarily drawn to scale, the emphasis instead being placed upon clearly illustrating the principles of the present disclosure. Moreover, in the drawings, like reference numerals designate corresponding portions throughout the several views.

FIG. 1 is a block diagram of an optical touch display, in accordance with an exemplary embodiment.

FIG. 2 is a schematic diagram of a scanning circuit of the optical touch display of FIG. 1, in accordance with an exemplary embodiment.

### DETAILED DESCRIPTION

Embodiments of the present disclosure will be described, with reference to the accompanying drawings.

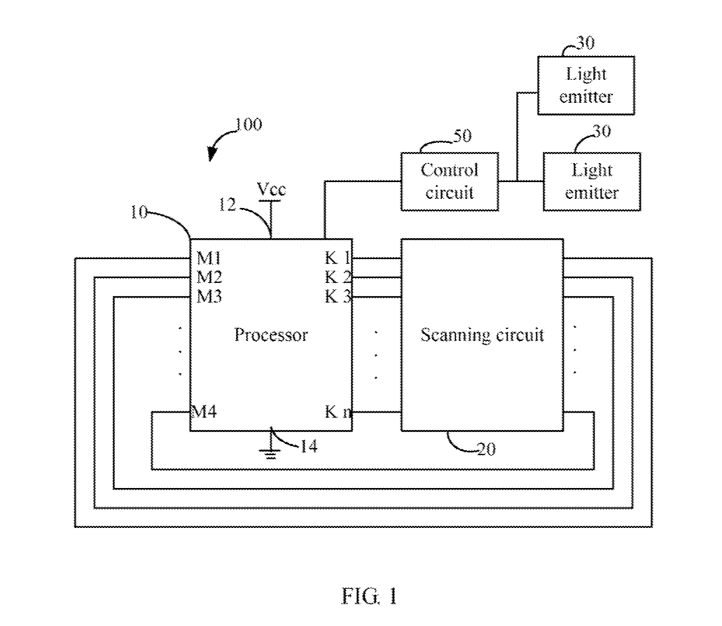

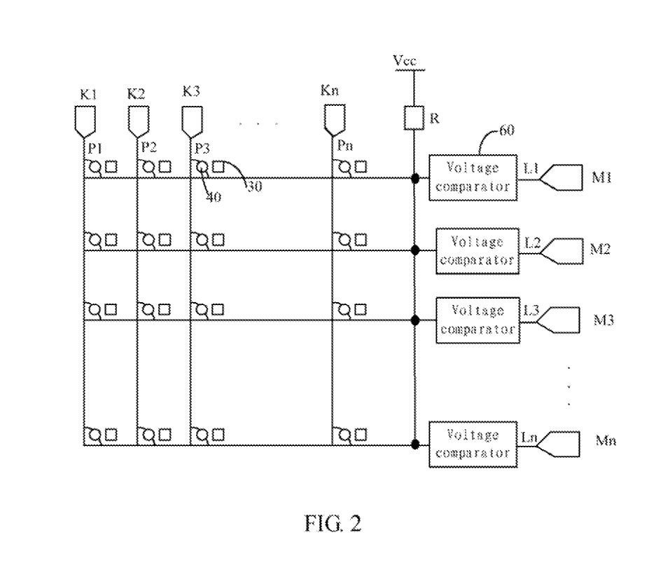

Referring to FIGS. 1-2, an embodiment of an optical touch display 100 is illustrated. The display 100 includes a processor 10, a scanning circuit 20, a number of light emitters 30, a number of light receivers 40, and a control circuit 50. The processor 10 includes a power port 12 connected to a power source Vcc and a ground port 14. The processor 10 further includes n output ports K1˜Kn and n input ports M1˜Mn.

The scanning circuit 20 includes n column wires P1˜Pn and n row wires L1˜Ln, constituting a matrix including intersection points. The n column wires P1˜Pn are respectively connected to the n output ports K1˜Kn in sequence. The n row wires L1˜Ln are respectively connected to the n input ports M1˜Mn in sequence via n voltage comparators. That is, the column wire P1 is connected to the output port K1, the column wire P2 is connected to the output K2, . . . , the column wire Pn is connected to the output port Kn. The row wire L1 is connected to the input port M1 via the voltage comparator 60, the row wire L2 is connected to the input port M2 via the voltage comparator 60, . . . , and the row wire Ln is connected to the input port Mn via the voltage comparator 60. In this embodiment, each voltage comparator 60 includes a first input port (not shown), a second input port (not shown), and an output port (not shown). The input voltage at the first input port is the reference voltage, and the second input port is connected to one row wire. The voltage comparator 60 controls the output port of the voltage comparator 60 to output a digital-high voltage or a digital-low voltage according to a comparison between the reference voltage and the voltage at the second input port.

In this embodiment, each light emitter 30 is arranged at one intersection point in the matrix, and can emit light in any outward direction. Each light receiver 40 is arranged at one intersection point, with two ends of each light receiver 40 being connected to one column wire and one row wire. When one intersection point is touched, the light from the light emitter 30 at that intersection point is reflected to the light receiver 40 at the same intersection point. In this embodiment, when one light receiver 40 receives light, the resistance of the light receiver 40 changes, thus the voltage at the second input port of each voltage comparator 60 accordingly changes. When the change of the resistance of one light receiver 40 falls within a preset range, the voltage at the output port of the voltage comparator 60 is high.

In a scanning period, the processor 10 first sets the voltages at all the n output ports K1˜Kn to be low simultaneously, and then sets the voltages at each of the n outputs K1˜Kn to be high in sequence. When the voltage at one output port is high, the processor 10 directs the control circuit 50 to first turn on all the light emitters 30 simultaneously, and then turn off all the light emitters 30 simultaneously. Upon the voltage at one output port being set to be high, when the processor 10 detects that the voltage of one input port is high when the light emitters 30 are on, and the voltage at the one input port is changed from high to low when the light emitters 30 are off, the processor 10 determines that a touch has been applied to the intersection point of the column wire connected to the output port at which voltage is high and the row wire connected to the input port at which voltage changes from high to low. For example, if the intersection point P1L1 formed by the column wire P1 and the row wire L1 is touched by a finger, when the voltage at the output port K1 is high, and the light emitter 30 at the intersection point P1L1 is on, the light from that light emitter 30 is reflected by the finger to the light receiver 40 at the intersection point P1L1. The resistance of that light receiver 40 accordingly changes, and the change falls within the preset range, thus the voltage at the output port of the voltage comparator 60 is set to be high, and the voltage of the input port M1 is accordingly high. When the light emitter 30 at the intersection point P1L1 is off, the light receiver 40 at the intersection point P1L1 cannot receive outside light because the finger is blocking the light, thus the resistance of that light receiver 40 does not change, and the voltage at the output port of the voltage comparator 60 is set to be low, and the voltage at the input port M1 is accordingly changed from high to low. Therefore, the processor 10 determines that the intersection point P1L1 has been touched. The processor 10 can determine touches on all intersection points within one scanning period.

In this embodiment, all the column wires are equidistant, and all the row wires are equidistant. In this embodiment, the processor 10 constitutes a Descartes coordinate system by regarding the column wire P1 as the y-axis, the row wire Ln as the x-axis, and the intersection point between the column wire P1 and the row wire Ln as the origin. The processor 10 determines the coordinates of any touched intersection point according to the coordinate system, the distance between each two adjacent column wires, and the distance between each two adjacent row wires. In other embodiment, the processor 10 can make determinations based on other coordinate systems.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An optically-sensitive touch display comprising:
a processor comprising n output ports K1˜Kn and n input ports M1˜Mn;
a scanning circuit comprising n column wires P1˜Pn and n row wires L1˜Ln which constitute a matrix comprising a plurality of intersection points, the n column wires P1˜Pn being respectively connected to the output ports K1˜Kn in sequence, the n row wires L1˜Ln being respectively connected to the input ports M1˜Mn in sequence via a plurality of voltage comparators;
a plurality of light emitters each arranged at one intersection point;
a plurality of light receivers each arranged at one intersection point, with two ends of each light receiver being respectively connected to one column wire and one row wire, when one intersection point being touched, the light from the light emitter at the touched intersection point being reflected to the light receiver at the touched intersection point; and
a control circuit configured to turn on and turn off the light emitters under the control of the processor;
wherein, in a scanning period, the processor first sets the voltage at all the n output ports K1˜Kn to be low simultaneously, and then sets the voltage at each of the n output ports K1˜Kn to be high in sequence, when one of the output ports K1˜Kn being set to be high, the processor controls the control circuit to turn on all the light emitters simultaneously, and then turn off all the light emitters simultaneously; upon one of the output ports K1˜Kn being set to be high, when the processor detects that the voltage at one of the input ports M1˜Mn is high when the light emitters are turned on, and the voltage at the one of the input ports M1˜Mn is changed to be low when the light emitters are turned off, the processor determines that a touch has been applied to the intersection point of the column wire connected to the output port at which voltage is high and the row wire connected to the input port at which voltage is changed from high to low.

2. The touch display as described in claim 1, wherein the column wires are equidistant, the row wires are equidistant, the processor constitutes a coordinate system by regarding the column wire P1 as the y-axis, the row wire Ln as the x-axis, and the intersection point formed by the column wire P1 and the row wire Ln as the origin, the processor determines the coordinate of one touched intersection point according to the coordinate system, the distance between each two adjacent column wires, and the distance between each two adjacent row wires.

3. The touch display as described in claim 1, wherein when one of the light receivers receives light, the resistance of the one of the light receivers changes, when the change of the resistance of the one of the light receivers falls within a preset range, the voltage comparator connected to the one of the light receivers outputs digital-high voltage.
